(19) United States
(12) Patent Application Publication
(10) Pub. No.: US 2004/0264301 A1
(43) Pub. Date: Dec. 30, 2004

(54) Calendar user interface

(75) Inventors: Dane M. Howard, Sammamish, WA (US); Keith C. Curtis, Seattle, WA (US); James W. Cooley, Redmond, WA (US)

Correspondence Address: MICROSOFT CORPORATION, C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/611,373

(22) Filed: Jun. 30, 2003

(51) Int. Cl. G09G 5/00; G04B 19/24

(52) U.S. Cl. 368/28; 968/170; 968/173; 968/400

(57) ABSTRACT

An apparatus and method are related to navigating through calendar based information on a device. Calendar based content associated with a calendar channel is stored on the device. The device includes modes for categorically displaying different types of information associated with the calendar channel. Example modes include: appointments view, event view, and month view. The appointment view mode is organized to display appointment information on the electronic device. The event view mode is arranged to display event information that is organized according to a day list format. The month view mode displays the days of the month. The calendar channel is synchronized and customized by the user from a single user interface.

### FIELD OF THE INVENTION

The present invention relates generally to user interfaces. More particularly, the present invention relates to an apparatus and method for providing a calendar interface on an electronic device such as a watch.

### BACKGROUND OF THE INVENTION

As society becomes increasingly mobile, mobile electronic devices are enjoying a tidal wave of popularity and growth. Cell phones, wireless PDAs, wireless laptops and other mobile communication devices are making impressive inroads with mainstream customers. Some types of mobile electronic devices are processor-controlled, with a user interface to allow the user to more easily and intuitively operate the device. For example, some mobile telephones include a display unit that displays graphical data to support email, web browser, and other non-voice features. Manufacturer of mobile electronic devices often utilize buttons on the mobile electronic device to navigate through various menus and display the graphical data.

### SUMMARY OF THE INVENTION

An apparatus and method are related to navigating through calendar based information on a device. Calendar based content associated with a calendar channel is stored on the device. The device includes modes for categorically displaying different types of information associated with the calendar channel. Example modes include: appointments view, event view, and month view. The appointment view mode is organized to display appointment information on the electronic device. The event view mode is arranged to display event information that is organized according to a day list format. The month view mode displays the days of the month. The calendar channel is synchronized and customized by the user from a single user interface.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS

FIG. 1 is a diagram illustrating an operating environment;

FIG. 2 is a schematic diagram illustrating an electronic device;

FIGS. 3A-3B are diagrams that illustrate watch devices that include a user interface;

FIG. 4 is a block diagram of a broadcast system that includes a configuration interface;

FIGS. 5A-5D are process flow diagrams for passive and active navigation functions of a electronic device; and

FIGS. 6-11 are diagrams illustrating example views for various modes in the calendar interface; which are arranged in accordance with the present invention.

### DETAILED DESCRIPTION OF THE PREFERRED EMBODIMENT

The present invention is described in the context of a user interface for an electronic device. In the described embodiments, the electronic devices may be watch type devices that are specially configured to receive communication signals. As will become apparent from a reading of the following detailed description, the electronic devices may be configured to receive broadcast transmission from one or more broadcast towers. The electronic devices may be capable of receiving and processing messages from the broadcast transmissions. The electronic devices store the received information such that the information is indexed according to designated channels. After information is received and processed by the client device, a user may passively or actively review the information that is stored in the electronic device. One of the particular channels corresponds to a calendar channel. The calendar channel on each device may be customized based on user preferences such that the user experience is enhanced. An example calendar channel may be configured to schedule: recurring appointments, non-recurring appointments, sporting events, concerts, television program schedules, to name a few.

Although described here in the context of a watch-based system, it will be apparent that the teachings of the application have equal applicability to any other mobile or non-mobile devices, such as portable and desktop computers, personal digital assistants (PDAs), cellular telephones, and the like. The use of a watch is for illustrative purposes only to simplify the following discussion, and may be used interchangeably with “mobile device” and/or “electronic device”.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are included within the scope of computer readable media.

The term “content” can be any information that may be stored in an electronic device. By way of example, and not limitation, content may comprise graphical information, textual information, and any combination of graphical and textual information. Content may be displayable information or auditory information. Auditory information may comprise a single sound or a stream of sounds.

The apparatus, system, and method of the present invention are related to navigating through content on a device that includes stored information that is related to time based appointments that are associated with a calendar. Content that is associated with the calendar channel may be selected and viewed on a display of the device by means of passive interaction (e.g., hands free operation). The views on the device can also be manually advanced through active user interaction.

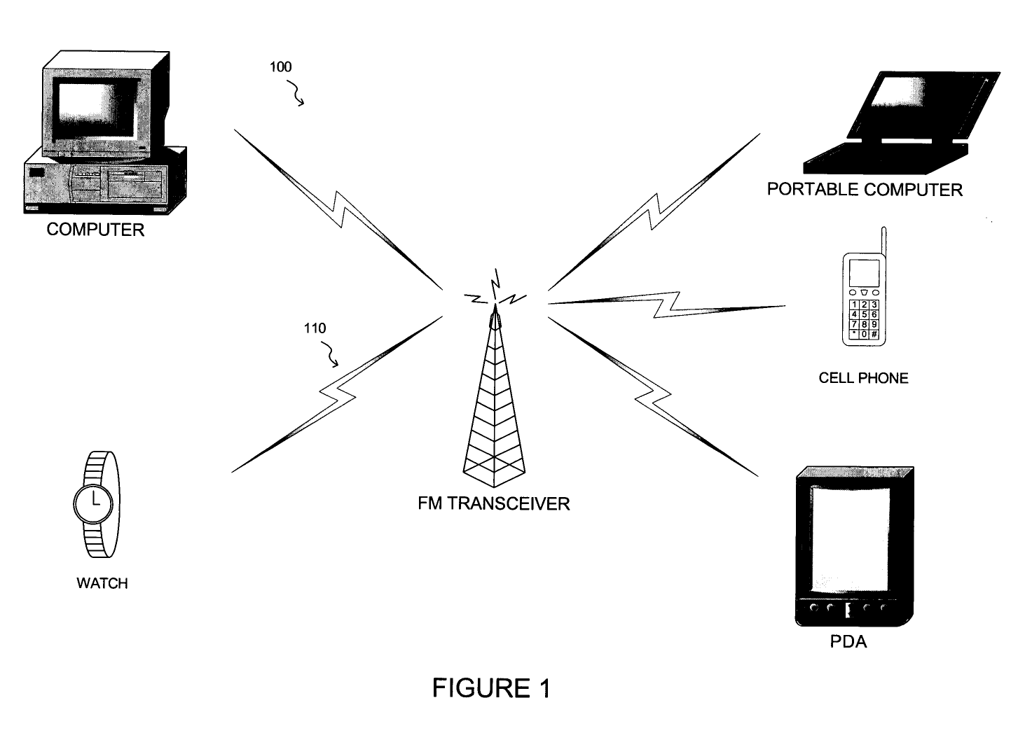

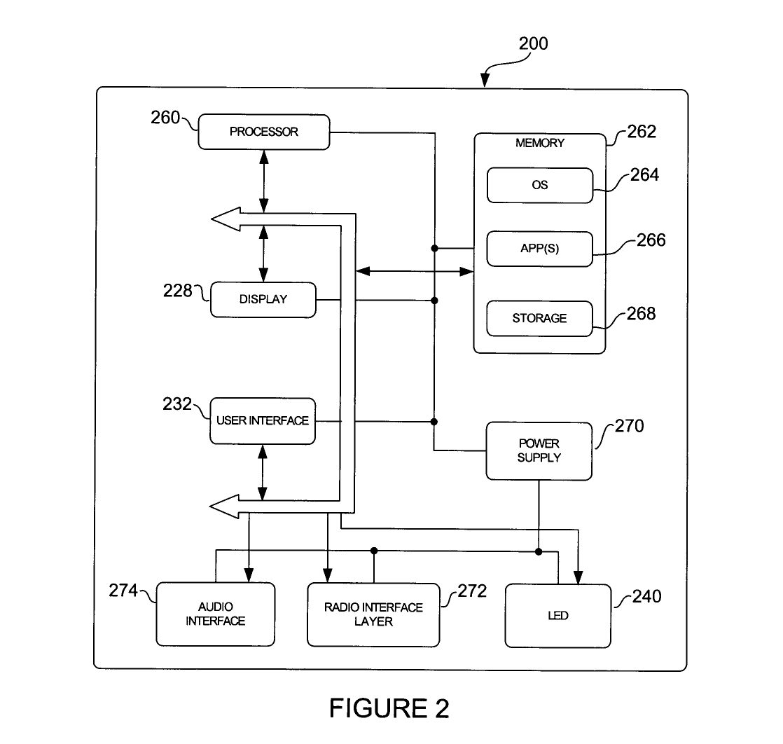

The overall operating environment for the present invention will be discussed as follows below with reference to FIGS. 1-2.

### Operating Environment

FIG. 1 illustrates an example operating environment (100) for the present invention. As illustrated in the figure, an FM transceiver or broadcast is transmitted over a communication channel (110) to various electronic devices. Example electronic devices that have an FM receiver or transceiver may include a desktop computer, a watch, a portable computer, a wireless cellular telephone (cell phone), and a personal data assistant (PDA). The electronic devices are arranged to receive information from the FM broadcast. The FM broadcast may be of any number of types including but not limited to: a standard FM transmission, a sub-carrier FM transmission, or any other type of FM transmission as may be desired.

Example electronic devices that may include an electronic system that is arranged to operate according to the interaction model are illustrated in FIG. 1. The electronic system may employ a wireless interface such as the FM transmission systems that are described above. Each of the electronic systems receives messages/information over the communication channel.

Each broadcast transmission corresponds to the transmission of one or more frames. Each frame may include multiple messages, where some messages are public broadcast (aka “global” or “shared” messages), while other messages are client specific messages (aka “personal” or “private” messages). Every client that is located within the designated service region may receive shared messages, while a single client may decode a private message.

Electronic devices (e.g., a wireless watch device) receive message packets according to shared and private messages that are directed to the client device. Message packets are organized in groups according to logical slot (or channel) entry numbers. For example, a particular electronic device is configured to receive a selected group of channels from the available channels. The message packets associated with each of those channels is received, processed, and stored in the client device. The stored message packets can be reviewed using a user interface that employs an interaction model, in accordance with the present invention.

Example channels include: a time channel, a messages channel, a contact channel, a calendar channel, a weather channel, a stocks channel, a news channel, and a games channel. Messages associated with each channel include message content that is based on the particulars of the channel. For example, the calendar channel may include a series of appointments that are associated with particular times and days of the month. In this example, each of the calendared appointments can be selected and reviewed by selecting the calendar channel on the electronic device.

### Illustrative Electronic System

FIG. 2 is a schematic diagram illustrating functional components of an illustrative electronic device (200). The electronic device (200) has a processor (260), a memory (262), a display (228), and a user interface (232). The memory (262) generally includes both volatile memory (e.g., RAM) and non-volatile memory (e.g., ROM, Flash Memory, or the like). The electronic device (200) includes an operating system (264), such as the Windows CE operating system from Microsoft Corporation or another operating system, which is resident in the memory (262) and executes on the processor (260). The user interface (232) may be a series of push buttons, a scroll wheel, a numeric dialing pad (such as on a typical telephone), or another type of user interface means. The display (228) may be a liquid crystal display, or any other type of display commonly used in electronic devices. In one example, the display (228) may be touch-sensitive that would act as an input device.

One or more application programs (266) are loaded into memory (262) and run on the operating system (264). Examples of application programs include phone dialer programs, email programs, scheduling/calendaring programs, PIM (personal information management) programs, Internet browser programs, and so forth. The electronic device (200) also includes a non-volatile storage (268) that is located within the memory (262). The non-volatile storage (268) may be used to store persistent information which should not be lost if the electronic device (200) is powered down. The applications (266) may use and store information in the storage (268), such as e-mail or other messages used by an e-mail application, contact information used by a PIM, appointment information used by a scheduling program, documents used by a word processing application, and the like.

The electronic device (200) has a power supply (270), which may be implemented as one or more batteries. The power supply (270) might further include an external power source, such as an AC adapter or a powered docking cradle that supplements or recharges the batteries.

The electronic device (200) is also shown with two types of external notification mechanisms: an LED (240) and an audio interface (274). These devices may be directly coupled to the power supply (270) so that when activated, they remain on for a duration dictated by the notification mechanism even though the processor (260) and other components might shut down to conserve battery power. The LED (240) may be programmed to remain on indefinitely until the user takes action to indicate the powered-on status of the device. The audio interface (274) is used to provide audible signals to and receive audible signals from the user. For example, the audio interface (274) may be coupled to a speaker for providing audible output and to a microphone for receiving audible input, such as to facilitate a telephone conversation, or as a user interface using voice recognition. In another example, a vibration device (not shown) can be used to give feedback to the user such as for alerting the user of a newly arrived message. The electronic device (200) can control each alert mechanism separately (e.g., audio, vibration, as well as visual cues).

The electronic device (200) also includes a radio interface layer (272) that performs the function of receiving and/or transmitting radio frequency communications. The radio interface layer (272) facilitates wireless connectivity between the electronic device (200) and the outside world, via a communications carrier or service provider. Transmissions to and from the radio interface layer (272) are conducted under control of the operating system (264). In other words, communications received by the radio interface layer (272) may be disseminated to application programs (266) via the operating system (264), and vice versa.

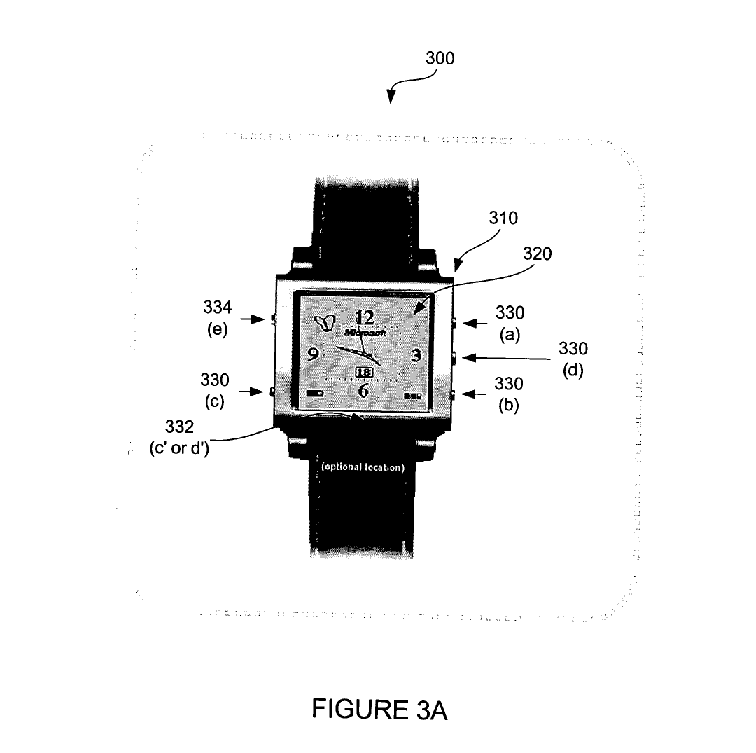

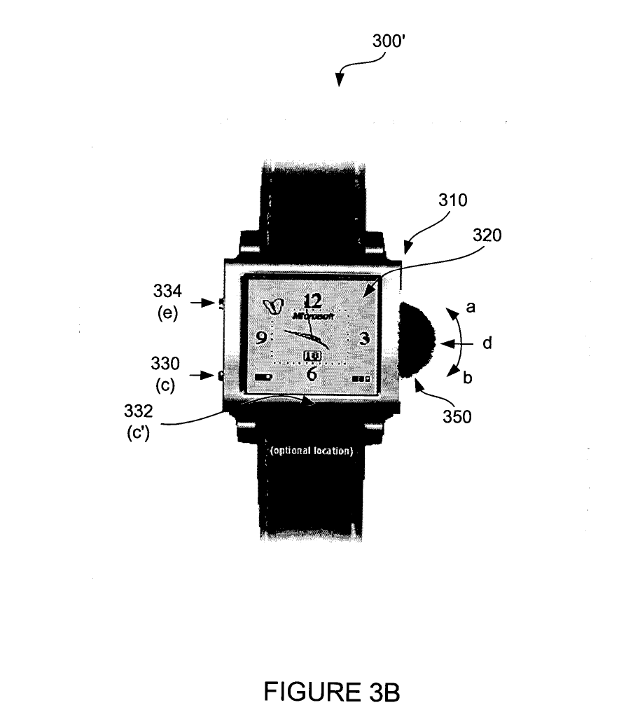

In one example of the present invention, electronic device 200 is a mobile electronic device such as a watch device that includes a wireless interface. Exemplary user interfaces for a watch device are shown in FIGS. 3A and 3B, as will be described below. Although the below-described user interface configurations include multiple selector buttons (e.g., four selector buttons), the functions of many of the selector buttons may be combined by a single selector (e.g., a button, a rocket switch, a wheel, etc.).

### User Interfaces (UI)

FIG. 3A illustrates an exemplary watch device (300) that includes a user interface that is configured for a calendar interface. The watch device (300) includes a bezel (310), which has an electronic system (e.g., see FIG. 2). The electronic system performs the functions in a manner that is consistent with the hardware that was previously described with respect to FIG. 2. The bezel (310) has a display (320) such as a liquid crystal display, a multiple bit display, or a full color display. In one embodiment, watch hands are electronically generated on the display (320). In an alternative embodiment, the bezel includes analog-type watch hands that do not detrimentally interfere with the display (320). The watch device (300) includes a series of selectors such as buttons (330) that are arranged to operate as part of a user interface (UI).

Every selector (e.g., buttons 330) has a default function, and/or a context determined function. The currently selected channel determines the context for each selector. Alternatively, the currently active display may determine the context for each selector. For example, a display screen (e.g., a help screen) may be superimposed on the main display such that the display screen becomes the active context. The electronic device (300) is context sensitive in that the function that is associated with each selector may change based on the selected channel or display screen.

A first one of the selectors, button “a” (330) has a default function of page up or previous page in the currently selected channel. The first selector, button “a” (330), also has an alternate function based on currently selected channel or display. For example, the first (e.g., “a”) selector may be configured to activate a list browse function after the “a” selector is activated for a predetermined time interval. In the list browse function, a pop-up visual cue (e.g., a pop-up window) indicates how that list is indexed. Each record (e.g., a day of appointments or events, a full month view calendar, etc.) can be indexed by things such as date, month, categories, or any other way of indexing a record. The list browse indexing allows a user to quickly access records located within the list.

In one example, the calendar channel may include a calendar view that includes a graphical representation of the current month in a graphical format (e.g., see FIG. 11). When the currently selected view is the calendar view, the first selector may be activated to select the previous month, or selecting a list browse function for choosing a month view. The list browse function may be activated by depressing the first selector for a predetermined time period. For example, when the selector is a button as shown in FIG. 3A, the button may be held for a timeout interval such as two seconds before the month view browser feature is activated.

A second one for the selectors, button “b” (330) has a default function of page down or next page in the currently selected channel. The second selector, button “b” (330), may also have an alternate function based on currently selected channel or display. In one example, the second selector is activated for a predetermined time interval (e.g., two seconds) to select “delete appointment” function in the calendar channel. In another example, the second selector is activated for a predetermined time interval to select a “list browse” function in the calendar channel (e.g., see previous discussion).

A third one of the selectors, button “c” (330) has a default function of next channel. The third selector, button “c” (330), may also have an alternate function based on the currently selected channel or display. In one example, the third selector is activated for a predetermined time interval (e.g., two seconds) to select the main channel or “primary” channel. The main channel in an example watch device is the time screen. However, devices may be configured to have some other display screen that is recognized by the device as a “primary” channel or “home” location. In another example, the third selector is activated to dismiss a pop-up window such as a scheduled alert.

A fourth one of the selectors, button “d” (330) has a default (or “primary”) function of “enter”. The “enter” function is context sensitive and used to select the “enter” function within a selected channel (e.g., enter Appointment Mode), or to select an item from a selection list (e.g., select November Appointments in a calendar view list browse). The fourth selector, button “d” (330), may also have an alternate function based on the currently selected channel or display. For example, the fourth selector is activated for a predetermined time interval (e.g., two seconds) to activate a help screen or an additional set mode. In this example, the help screen remains active while the fourth selector is activated (e.g., maintaining button “d” as depressed), and the help screen is deactivated (e.g., removed from the display) when the fourth selector is deactivated (e.g., by releasing button “d”).

The four selectors are arranged such that the electronic device accomplishes navigating and selecting content on each channel in a simple manner. An optional fifth selector (e.g., button “e”, 334) may be arranged to provide other functions such as backlighting or another desired function. An optional sixth selector (e.g., button “f”) may be arranged to operate as a “channel back” function such that navigation through channels may be accomplished in a forward and reverse direction.

In an alternative example, the third selector (e.g., button “c”) may be located in the bottom center region of the watch bezel as illustrated by selector 332. In yet another example, the fourth selector (e.g., button “d”) is located in the bottom center region of the watch bezel as illustrated by selector 332.

FIG. 3B illustrates another exemplary watch device (300′) that includes a user interface to an electronic system that is configured to operate in accordance with the present invention. The watch device (300) is arranged in a substantially similar manner as that discussed with respect to FIG. 3A. However, the first, second, and third selectors (e.g., buttons “a”, “b”, and “d”) are replaced with a wheel type of device (350). The functions of the “a” and “b” selectors are activated by rotating the wheel device (350) in a counterclockwise and clockwise manner. The functions of the “d” selector are activated by pressing the wheel device (350) towards the watch bezel.

In an alternative example, the “a” and “b” button-type selectors are replaced by a rocker-type of switch that may be depressed toward the locations of the “a” and “b” selectors illustrated in FIGS. 3A and 3B. In still another example, a touch screen interface is employed as the selectors for the watch device. Other examples of selector mechanisms may be employed.

The description that follows below includes examples of communication between broadcast towers and client devices such that client devices receive and store content. The communication method is for illustrative purposes only and is not required by every client device. Any client device that navigates stored content is considered within the scope of the described systems and methods.

### Broadcast Channels

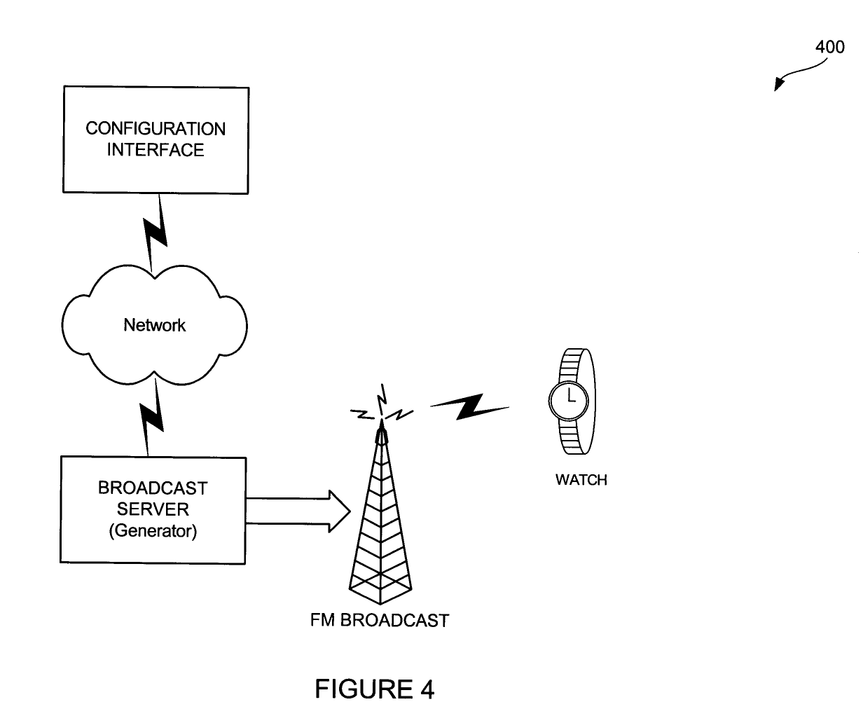

Each broadcast transmitter tower is arranged to provide a communication signal that is configured for reception by electronic devices that are located within a service region. An exemplary FM broadcast tower transmits signal as directed by a broadcast server device as shown in FIG. 4. The broadcast server device (aka a “generator”) may communicate with a configuration interface via a network communication link.

The configuration interface is configured as a means for selecting one or more services. In one example, a wireless client device user interacts with the scheduling interface to select services such as news, stock prices, weather, and other features such as a personal calendar, address book, and the like. Selected services are entered in a database for broadcast transmission at a later time. At the designated time (or time interval) the scheduling interface communicates with the broadcast server to begin a transmission sequence of data for the selected services. The broadcast server subsequently formats the data for reception by one or more wireless client device, queues the data for transmission, and communicates the queued data to the FM broadcast tower for transmission. In an alternative example, the scheduling interface communicates the selected services to the broadcast server. The broadcast server schedules the time interval for transmission of the selected service.

Each broadcast transmission corresponds to the transmission of one or more frames that are arranged in accordance with a frame protocol. Each frame may include multiple messages, where some messages are public broadcast (aka “global” or “shared” messages), while other messages are client specific messages (aka “personal” or “private” messages). Each frame includes a table of contents that indicates the extent of messages that are found within the next transmitted frame. Every client that is located within the designated service region may receive shared messages, while a single client may decode a private message.

Each frame includes a header, a table of contents, and a message payload that includes the content for one or more selected services as previously described. The header also includes other information such as authentication data, identified service region, language, available stations for the identified service region, frame number, and time stamp. Control information may also be included in one of the headers to indicate broadcast conditions such as a change in available channels, an assignment of a service region to a particular wireless client device, and an assignment of a particular channel (frequency). In one example, each frame includes a change counter in one of the headers to indicate a change has taken place in the system. Wireless client devices (clients) may use the change counter to determine when to initiate a failover (when a broadcast tower becomes unavailable).

Client devices can determine the current service region based on information that is included in the broadcast transmissions. The time zone can be determined based on the current service region such that the client device can adjust appointments and schedules based on the current time zone. Moreover, the time and date functions of the client device may be synchronized based on information that is included in the broadcast transmissions.

### Process Flow

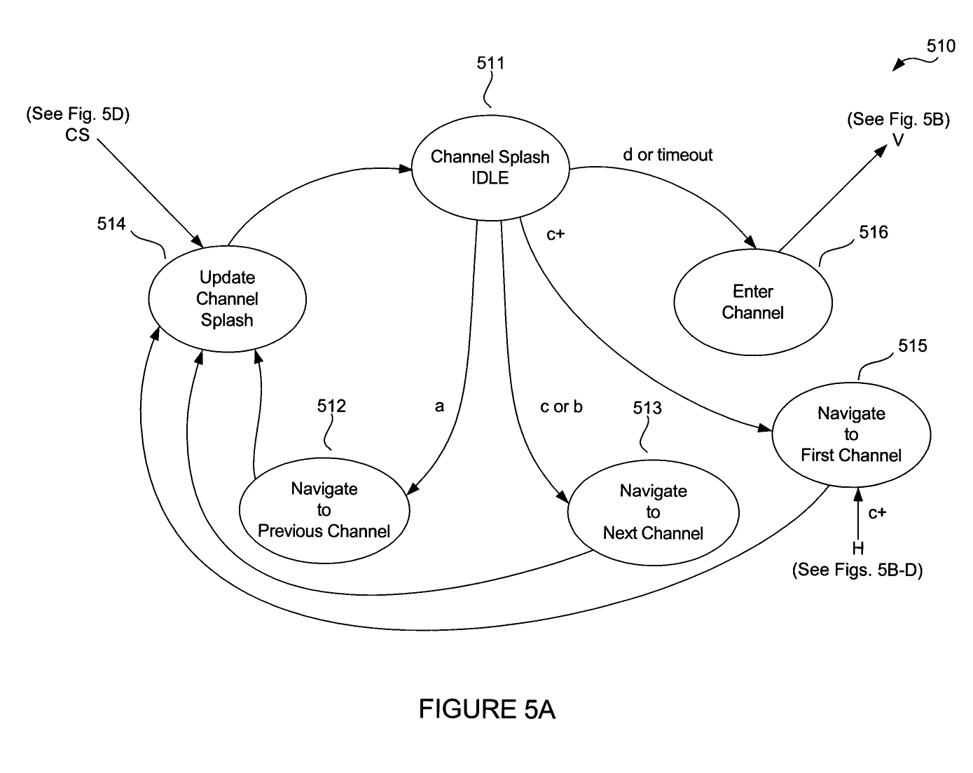

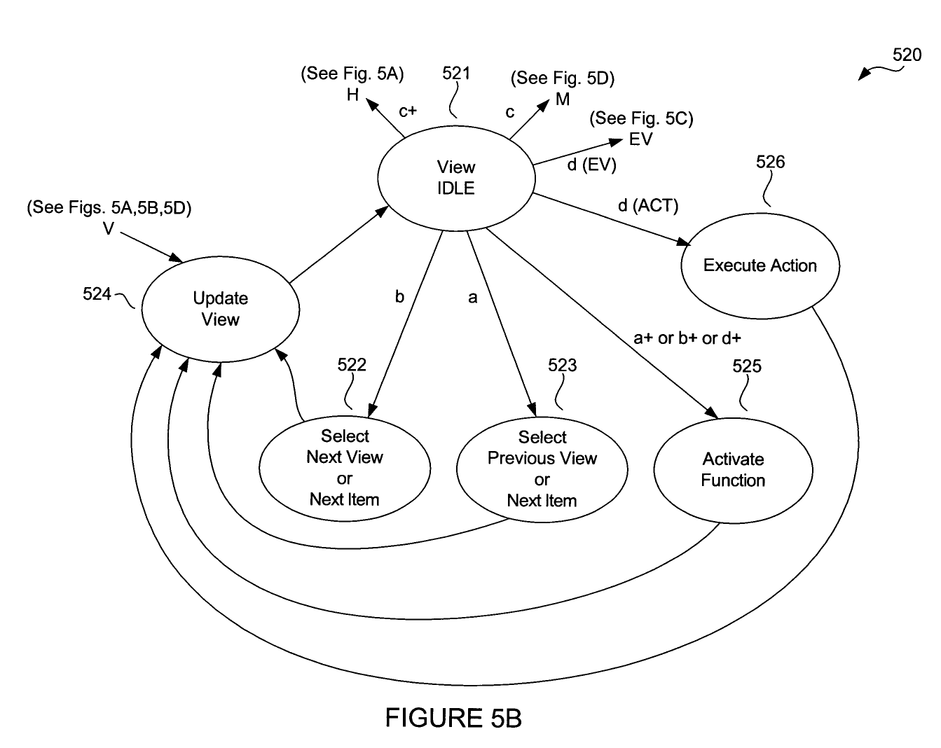

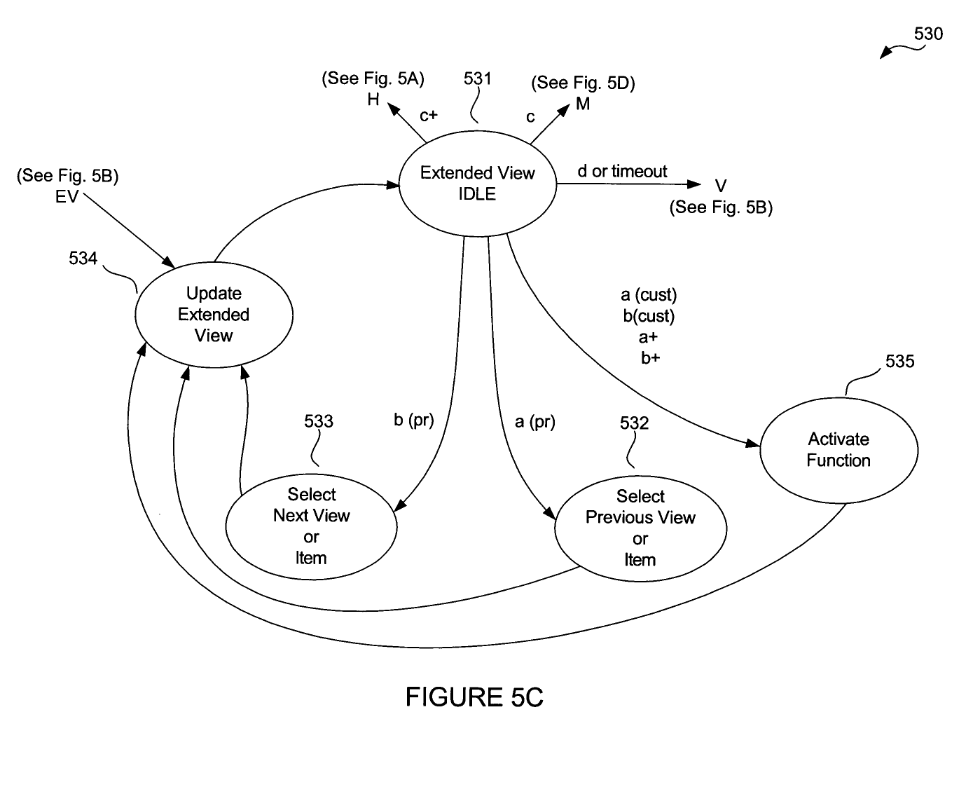

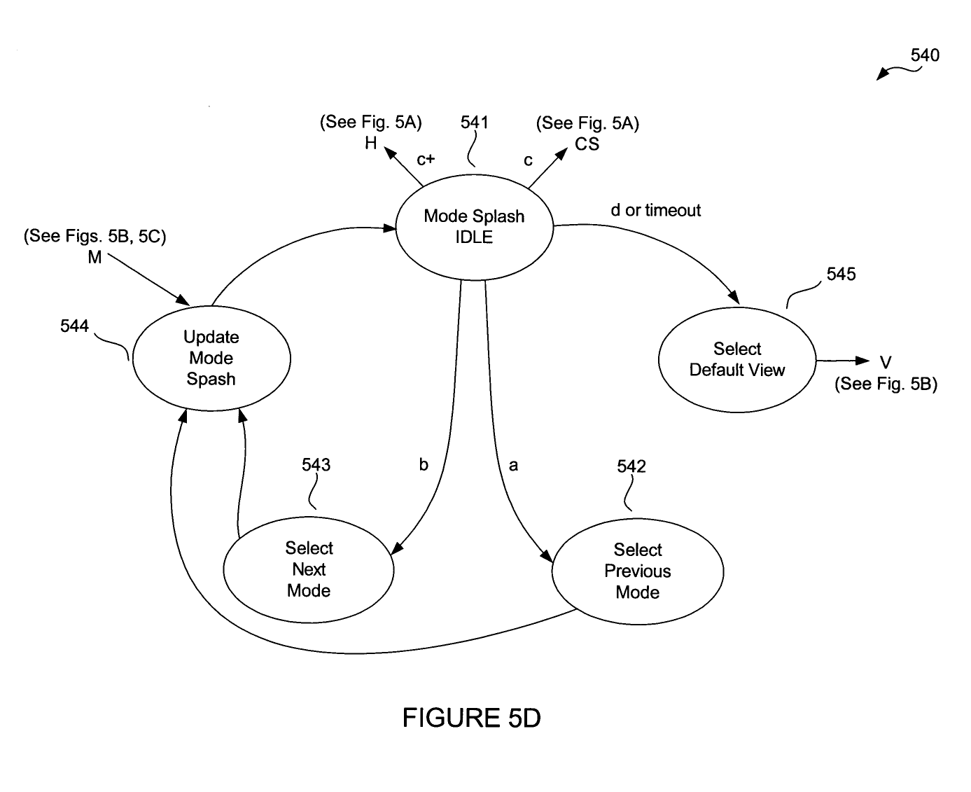

Process flow diagrams for navigation function of an example electronic device are illustrated in FIGS. 5A-5D. The process flow diagram illustrated in FIG. 5A is predominately focused on channel splash activity. The process flow diagram illustrated in FIG. 5B is predominately focused on view activity. The process flow diagram illustrated in FIG. 5C is predominately focused on extended view activity. The process flow diagram illustrated in FIG. 5D is predominately focused on mode splash activity.

Every electronic device has at least one channel that corresponds to the home channel. For a watch type of device, the home channel corresponds to a time channel. However, different home channels can be assigned to every electronic device. Whenever the currently selected channel corresponds to the home channel, the previous channel corresponds to the last channel (if more than one channel exists on the device). Similarly, the next channel corresponds to the home channel when the current channel is the last channel in the channel list for the electronic device.

Every electronic device has a set of selectors (or buttons) that are selectively activated to navigate various functions in the device. Example selectors are illustrated in FIGS. 3A-3B. For the purposes of the discussion below, each selector is indicated by a letter such as “a”, “b”, “c”, “d”, and “e”. Some alternate selector functions may be chosen by sustained activation of a selector button for a predetermined time interval (e.g., two seconds). The alternate selector functions are generally indicated in the figures by a “+” symbol that is adjacent to the selector functions' designating letter (e.g., “c+”).

The example electronic device described below includes at least four selectors as indicated by letters “a”, “b”, “c”, and “d”. The “e” selector may be arranged to provide additional functions such as backlighting, a back channel selector, as well as any other desired function. Additional extended functions may also be accessible through multiple selector combinations. For example, holding the “d” and “a” selectors together (“d+” & “a+”) for a predetermined time interval can be done to select special settings in the electronic device such as a “screen adjust” function. Additional extended functions can also be accomplished using other selector combinations such as “d+” & “b+”, “a+” & “b+”, as well as others.

### Channel Splash Operating State

The channel splash operating state is described as follows below with reference to FIG. 5A.

The electronic device activates the channel splash operating state when the electronic device is initialized (e.g., just after a power-up sequence). The electronic device has a default initial channel that is referred to as a home channel. The display is updated to indicate the currently selected channel at block 514. Processing continues to block 611 where the channel splash operating state is maintained in an idle state. The electronic system in the electronic device monitors the user interface (e.g., the four selector) while in the channel splash IDLE state. When the user activates one or more of the selectors (e.g., one of four selectors), processing leaves the channel splash IDLE state.

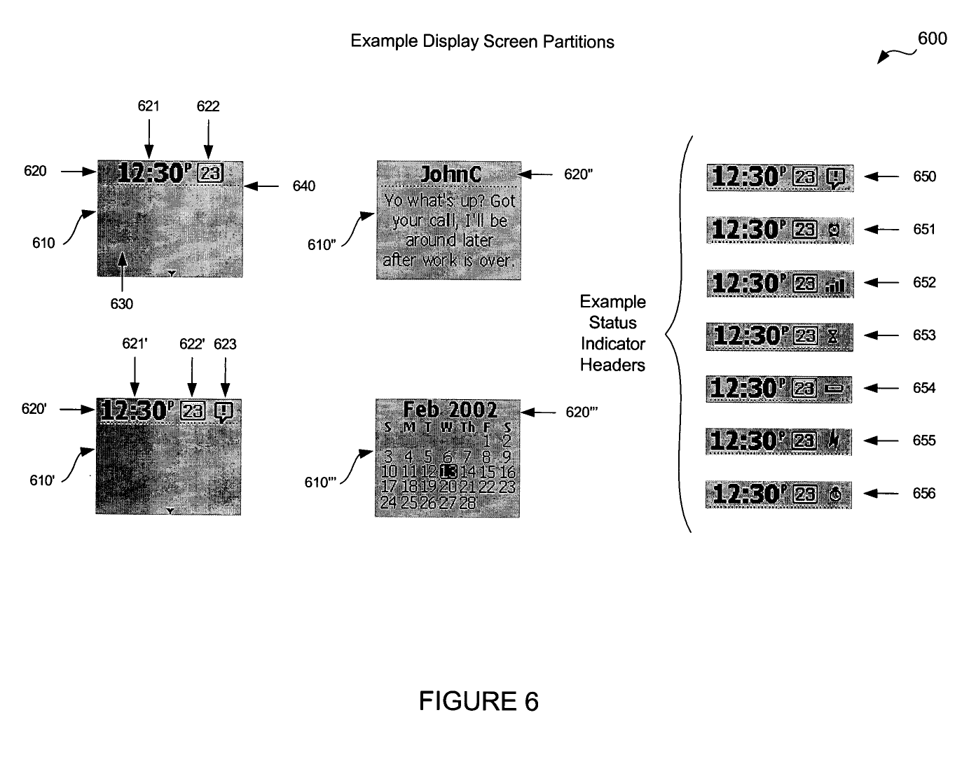

The display actively maintains the splash screen to indicate the current channel selection while the channel splash IDLE state is active at block 511. Splash screens may include one or more graphic elements and/or text elements. An example channel splash screen for a calendar channel is illustrated as 610 in FIG. 6. Channel splash screen 610 is illustrated as including a date indicator that changes for each day of the month. Splash screens may be accompanied by the activation of sound that provides an audible indicator that the channel has changed. The sound associated with the audible indicators may be the same for each channel splash screen, or unique based on either the particular channel or the particular channel type (e.g., news channels are one type, while messages are another type).

Processing flows from the channel splash IDLE state (511) to the “navigate up” or “navigate to previous channel” function (512) when the “a” selector is activated (e.g., depressing an “a” button). Processing continues from block 512 to block 514, where the display is updated based on the newly selected channel. After the display is updated, processing returns to the channel splash IDLE state (511).

Processing flows from the channel splash IDLE state (511) to the “navigate down” or “navigate to next channel” function (513) when either the “b” selector or the “c” selector is activated (e.g., depressing either the “b” or “c” button). Processing continues from block 513 to block 514, where the display is updated based on the newly selected channel. After the display is updated, processing again returns to the channel splash IDLE state (511).

Processing flows from the channel splash IDLE state (511) to the “navigate to first channel” or “navigate to home channel” function (515) when the “c+” selector is activated. The home channel navigation function can be accessed from any channel of the electronic device. The electronic device navigates to the home channel (e.g., the time channel on a watch device) when the “navigate to home channel” function is activated. Processing continues from block 513 to block 514, where the display is updated based on the newly selected channel (i.e., the home channel). After the display is updated, processing again returns to the channel splash IDLE state (511).

Processing flows from the channel splash IDLE state (511) to the “enter channel” function (516) when the “d” selector is activated (e.g., depressing a “d” button). Alternatively, the “enter channel” function is activated when the electronic system is maintained in the channel splash IDLE state for a predetermined time interval (e.g., a 2 second timeout) without activation of a selector. Processing flows from block 516 to block 524 (see FIG. 5B) when the “enter channel” function is activated as indicated by “V”.

The enter channel function performs a series of initializations in the electronic device prior to leaving the channel splash operating state and entering the channel view operating state. Every channel in the electronic device has at least one operating mode. The electronic device selects the current operating mode as a default mode, and a current view as a default view in the currently selected channel when the “enter channel” function is activated.

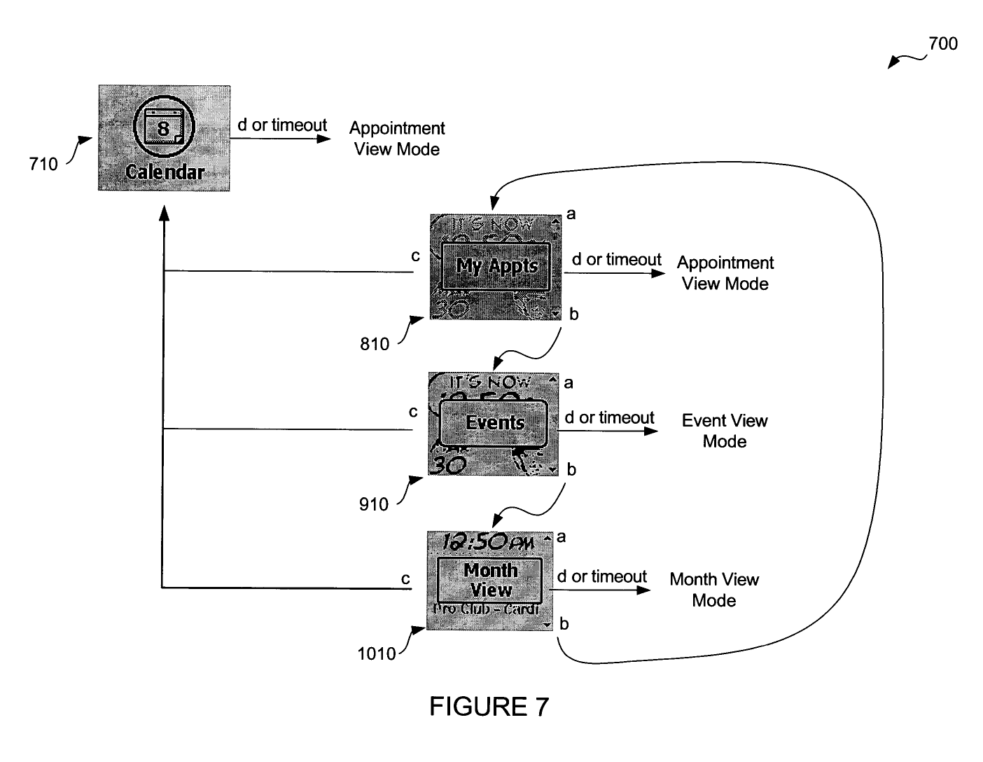

In one example, a calendar channel has an appointment operating mode, an event view operating mode, and a month view operating mode. Multiple views may be associated with each operating mode. In one example, a calendar channel may have views for each scheduled appointment in the appointment mode (e.g., see 720 in FIG. 7). In another example, a calendar channel may have a “no appointments” view when no appointments are scheduled in the appointment mode (e.g., see 740 in FIG. 7).

### Channel View Operating State

The channel view operating state is described as follows below with reference to FIG. 5B.

The electronic device enters the channel view operating state at entry point V, where the selector functions associated with the currently selected channel and operating mode are mapped to the selectors. The display is updated to indicate the currently selected view at block 524. Processing continues to block 521 where the channel view operating state is maintained in an IDLE state. The electronic system in the electronic device monitors the user interface (e.g., the four selector) while in the view IDLE state. When the user activates one or more of the four selectors, processing leaves the view IDLE state.

The display actively maintains the current view while the view IDLE state is active at block 521. List type views include lists of items that can be selected. Other types of views are simply graphical and/or textual elements that are arranged in a display view. Example views are illustrated in FIGS. 7 through 11. Views may be accompanied by the activation of sound that provides an audible indicator that the view has changed. The sound associated with the audible indicators may be the same for each view (e.g., a beep type of indicator or sound clip), or unique based on the particular view. In one example, an audible indicator is activated when a particular alert notification function is activated.

Processing flows from the view IDLE state (521) to the “previous view” or “previous item” function (522) when the “a” selector is activated (e.g., depressing an “a” button). Processing continues from block 522 to block 524, where the display is updated based on the newly selected view. After the display is updated, processing returns to the view IDLE state (521). In one example, the previous view corresponds to the last view when the currently selected view is the first available view in the current mode for the current channel. In another example, the previous view corresponds to an empty view (e.g., “no appointments”, “no events”, “no data”, etc.) when the currently selected view is the first available view in the current mode for the current channel. In still another example, the previous item in a list is highlighted when the “a” selector is activated.

Processing flows from the view IDLE state (521) to the “next view” or “next item” function (513) when the “b” selector is activated (e.g., depressing the “b” button). Processing continues from block 523 to block 524, where the display is updated based on the newly selected view. After the display is updated, processing again returns to the view IDLE state (521). In one example, the next view corresponds to the first view when the currently selected view is the last available view in the current mode for the current channel. In another example, the next view corresponds to an empty view (e.g., “no appointments”, “no events”, “no data”, etc.) when the currently selected view is the last available view in the current mode for the current channel. In still another example, the next item in a list is highlighted when the “b” selector is activated.

Processing flows from the view IDLE state (521) to the “mode splash” function when the “c” selector (e.g., “mode select”) is activated as indicated by “M”. Refer to FIG. 5D and related discussion for details.

Processing flows from the view IDLE state (521) to the select home channel splash function when the “c+” selector is activated as indicated by “H”. Refer to FIG. 5A and related discussion for details.

The “d” selector is defined within the context of the current channel, mode, and view. The “d” selector may be defined as an “enter extended view” function, a “select” function, or a “execute action” function. Not every view in a given channel/mode has an extended view as may be indicated by a null value. Some views may have an action function that is defined within the context of the view in the currently selected mode/channel. The context for each view is assigned to the mode upon entry into the mode for the current channel.

Processing flows from the view IDLE state (521) to the “enter extended view” function when the “d” selector is activated (e.g., depressing a “d” button) and the extended view is available as indicated by “d(EV)”. The extended view is available when defined within the context of the currently selected view. For example, the extended view may be available for a list type view such that the highlighted list item is selected when the “d” selector is activated, and a detailed view associated with the highlighted item is displayed as an extended view. Refer to FIG. 5C and related discussion for details on the extended view processing.

Processing flows from the view IDLE state (521) to the “execute action” function at block 526 when the “d” selector is activated and the action function is available as indicated by “d(ACT)”. The action function is defined within the context of the currently selected view. For example, a fortune cookie mode may be available in an entertainment channel. Although the fortune cookie mode may only have a single view, the “d” selector may be mapped to an action function that randomly selects fortunes from a list when the “d” selector is activated. After the action is performed (e.g., retrieve random fortune from list, execute an animation sequence), processing continues to block 524 where the display is updated as previously described.

Other special functions may be mapped to the “a+”, “b+”, and “d+” selectors within the context of the current view. By activating the corresponding selector for a predetermined time interval (e.g., 2 seconds) the corresponding special function is activated as indicated by block 525. Processing continues from block 525 to block 524 where the display is updated as previously described.

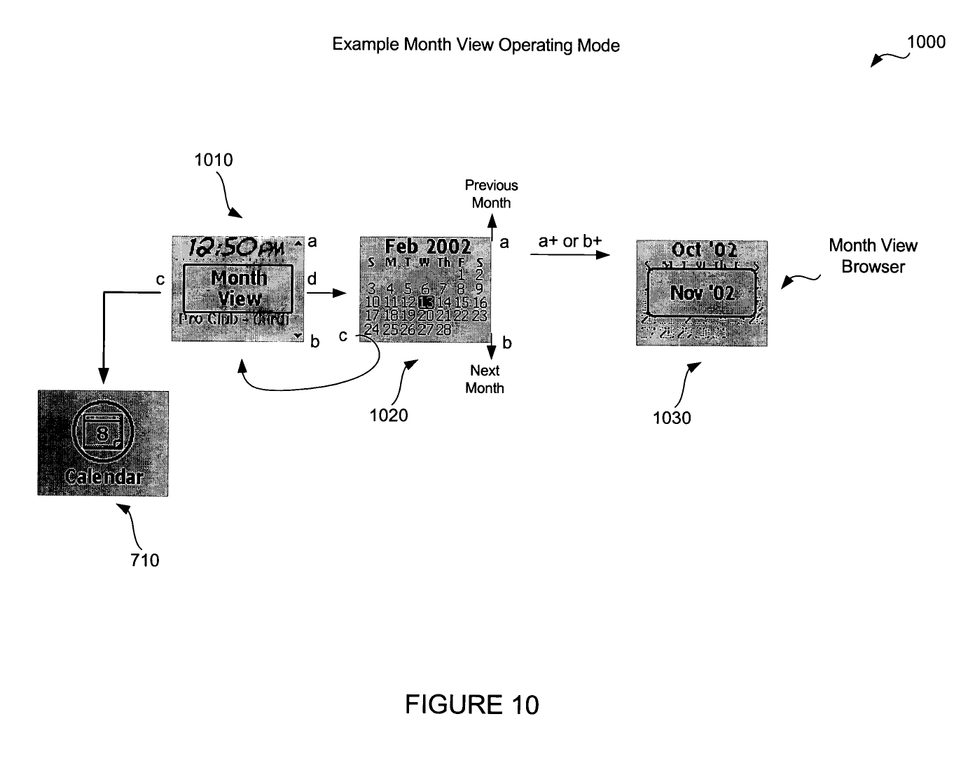

In one example, a list browser function is available in a mode that corresponds to a monthly view in the calendar channel. For this example, activation of the “a” and “b” selectors result in manual navigation through views that correspond to previous or subsequent months. Activation of the “a+” or “b+” selector may activate an index function that displays an index indicator (e.g., see 1030 in FIG. 10) such as “Nov. 03”, “Dec. 03”, “Jan 04”, etc. After the index function is active, the “a” and “b” are mapped into scroll up and down functions, “c” is mapped to a cancel function, and “d” and/or “timeout” are mapped to a select current index function. The indexing system can be any alpha-numeric type of indexing system as defined within the scope of the current view.

In another example, an erase function is available in a view that corresponds to a specific appointment in the appointment mode for the calendar channel. For this example, activation of the “a” and “b” selectors manually navigates through various appointments one at a time. Activation of the “d+” selector may activate an erase function that removes the currently selected appointment from the electronic device.

In still another example, processing may flow from the view IDLE state (521) to the “alternate view” function (e.g., see FIG. 11) when the electronic system is maintained in the channel splash IDLE state for a predetermined time interval (e.g., a 2 second timeout) without activation of a selector.

### Extended View Operating State

The extended view operating state is described as follows below with reference to FIG. 5C.

The electronic device enters the extended view operating state at entry point EV, where the selector functions associated with the currently selected extended view are mapped to the selectors. The display is updated to indicate the currently selected extended view at block 534. Processing continues to block 531 where the extended view operating state is maintained in an IDLE state. The electronic system in the electronic device monitors the user interface (e.g., the four selector) while in the extended view IDLE state. When the user activates one or more of the four selectors, processing leaves the extended view IDLE state.

The display actively maintains the current extended view while the extended view IDLE state is active at block 531. Extended views include graphical and/or textual elements that are arranged in a display view. Extended views may be accompanied by the activation of sound that provides an audible indicator that the extended view has changed. The sound associated with the audible indicators may be the same for each extended view (e.g., a beep type of indicator or sound clip), or unique based on the particular extended view.

Processing flows from the extended view IDLE state (531) to the “previous view” or “previous item” function (532) when the “a” selector is activated (e.g., depressing an “a” button). Processing continues from block 532 to block 534, where the display is updated based on the newly selected extended view. After the display is updated, processing returns to the extended view IDLE state (531). In one example, the previous view corresponds to the last extended view when the currently selected extended view is the first available extended view for the current channel/mode. In another example, the previous extended view corresponds to an empty view (e.g., “no appointments”, “no events”, “no data”, etc.) when the currently selected extended view is the first available extended view in the current channel/mode.

Processing flows from the extended view IDLE state (531) to the “next view” or “next item” function (533) when the “b” selector is activated (e.g., depressing an “b” button). Processing continues from block 533 to block 534, where the display is updated based on the newly selected extended view. After the display is updated, processing returns to the extended view IDLE state (531). In one example, the next view corresponds to the first extended view when the currently selected extended view is the last available extended view for the current channel/mode. In another example, the next extended view corresponds to an empty view (e.g., “no appointments”, “no events”, “no data”, etc.) when the currently selected extended view is the last available extended view in the current channel/mode.

Processing flows from the extended view IDLE state (531) to the “mode splash” function when the “c” selector (e.g., “mode select”) is activated as indicated by “M”. Refer to FIG. 5D and related discussion for details.

Processing flows from the extended view IDLE state (531) to the view function when the “d” selector is activated as indicated by “V”. In another example, processing flows from the extended view IDLE state (531) to the view function when a timeout interval expires (e.g., 5 seconds). Refer to FIG. 5B and related discussion for details concerning the view functions.

Processing flows from the extended view IDLE state (531) to the select home channel splash function when the “c+” selector is activated as indicated by “H”. Refer to FIG. 5A and related discussion for details.

Special functions may be mapped to the “a”, “b”, “a+”, and “b+” selectors within the context of the current view. By activating the corresponding selector for a predetermined time interval (e.g., a 2 second timeout interval) the corresponding special function is activated as indicated by block 535. Processing continues from block 535 to block 534 where the display is updated as previously described.

### Mode Splash Operating State

The model splash operating state is described as follows below with reference to FIG. 5D.

The electronic device enters the mode splash operating state at entry point M. The display is updated to indicate the currently selected mode at block 545. Processing continues to block 541 where the mode splash operating state is maintained in an IDLE state. The electronic system in the electronic device monitors the user interface (e.g., the four selector) while in the mode splash IDLE state. When the user activates one or more of the four selectors, processing leaves the mode splash IDLE state.

The display actively maintains the current mode splash display while the mode splash view IDLE state is active at block 541. Mode splash views include graphical and/or textual elements that are arranged in a display view. Example mode splash displays for a calendar channel are illustrated in FIG. 6. Mode splash displays may be accompanied by the activation of sound that provides an audible indicator that the selected mode has changed. The sound associated with the audible indicators may be the same for each mode splash (e.g., a beep type of indicator or sound clip), or unique based on the particular mode selected.

Processing flows from the mode splash IDLE state (541) to the “previous mode” function (542) when the “a” selector is activated (e.g., depressing an “a” button). Processing continues from block 542 to block 544, where the display is updated based on the newly selected mode. After the display is updated, processing returns to the mode splash IDLE state (541). In one example, the previous mode corresponds to the last mode when the currently selected mode is the first available mode for the current channel.

Processing flows from the mode splash IDLE state (541) to the “next mode” function (543) when the “b” selector is activated (e.g., depressing an “b” button). Processing continues from block 543 to block 544, where the display is updated based on the newly selected mode. After the display is updated, processing returns to the mode splash IDLE state (541). In one example, the next mode corresponds to the first mode when the currently selected mode is the last available mode for the current channel.

Processing flows from the mode splash IDLE state (541) to the “channel splash” function when the “c” selector (e.g., “channel select”) is activated as indicated by “CS”. Refer to FIG. 5A and related discussion for details.

Processing flows from the mode splash IDLE state (541) to the “select default view” function (545) when the “d” selector is activated. Alternatively, processing may flow from the mode splash IDLE state (541) to the “select default view” function (545) when a timeout interval (e.g., a 2 second interval) has expired. Processing continues from block 545 to the channel view operating state as indicated by “V”. Refer to FIG. 5B and related discussion for details.

Processing flows from the mode splash IDLE state (541) to the select home channel splash function when the “c+” selector is activated as indicated by “H”. Refer to FIG. 5A and related discussion for details.

### Example Display Screen Partitions

FIG. 6 is a diagram (600) illustrating views for display screens (610, 610′) on an example electronic device such as a watch that is arranged in accordance with the present invention. Example display screen (610) is partitioned into two regions: a header region (620) and a main body region (630).

The main body region of the display screen may include one or more graphical and/or textual information fields that change based on the current context in the current channel, mode, and operating state. In one example context, the main body region is a single text region for displaying a text message (610″). In another example context, the main body section (610″) may include a graphical representation of the current month in a calendar.

The header region of the display screen may include one or more graphical and/or textual information fields that change based on the current context in the current channel, mode, and operating state. In one example context, the header section (620) may include two regions: a current time field (621) and a current date field (622). In another example context, the header section (620′) may include three regions: a current time field (621′), a current date field (622′), and a status indicator field (623). In yet another example context (e.g., a message view), the header section (620″) includes an identifier for a message (e.g., the originator of the message might be “JohnC”). In still another example context (e.g., a calendar month view), the header section (620″) may include a single field for a date such as “February 2002”.

Status indicators may be associated with various conditions such as alerts in the electronic device. One example header (650) includes a status indicator for an internal alert such as an exclamation point symbol. Another example header (651) includes a status indicator that an alarm is set such as an alarm clock symbol. Yet example header (652) includes a status indicator of signal strength in a wireless connection such as signal strength bars. Still another example header (653) includes a status indicator that a timer is running such as an hourglass symbol. Yet still another example header (654) includes a status indicator that the battery is low such as an empty battery symbol. Still another example header (655) includes a status indicator that the battery is charging such as a lightning bolt symbol. Still yet another example header (656) includes a status indicator that a timer is running such as a chronograph symbol.

### Example Calendar Channel Views

FIGS. 7-11 are diagrams illustrating example views for various modes in a calendar user interface (UI) that is arranged in accordance with the present invention. The calendar channel may be configured for multiple operating modes. Example operating modes include an appointment mode, an event view mode, and a month view mode. Each operating mode may have a separate mode splash-screen, as illustrated in FIG. 7.

A mode splash-screen (e.g., see FIG. 7) is displayed when the mode is changed. In one example, the mode may be changed by selective activation of the next and previous selectors (e.g., the “a” and “b” buttons) when any mode splash screen is active (see FIG. 5D). The mode splash screen may be dismissed via a timeout condition or by activation of the “d” selector (or enter function). Each mode has a series of associated views.

A channel splash-screen (810) for the calendar channel is displayed when the calendar channel is initially selected. The calendar channel splash screen may include a date indicator as illustrated in FIG. 7, where the date on the splash screen changes for each day of the month. After the calendar channel is selected, the appointment mode is activated by the expiration of a timeout period (e.g., ten seconds) without user interaction, or by activation of the “d” or “enter” selector. The channel splash can be selected from any one of the mode splash screens by activation of the “c” selector (See FIG. 5D and FIG. 7).

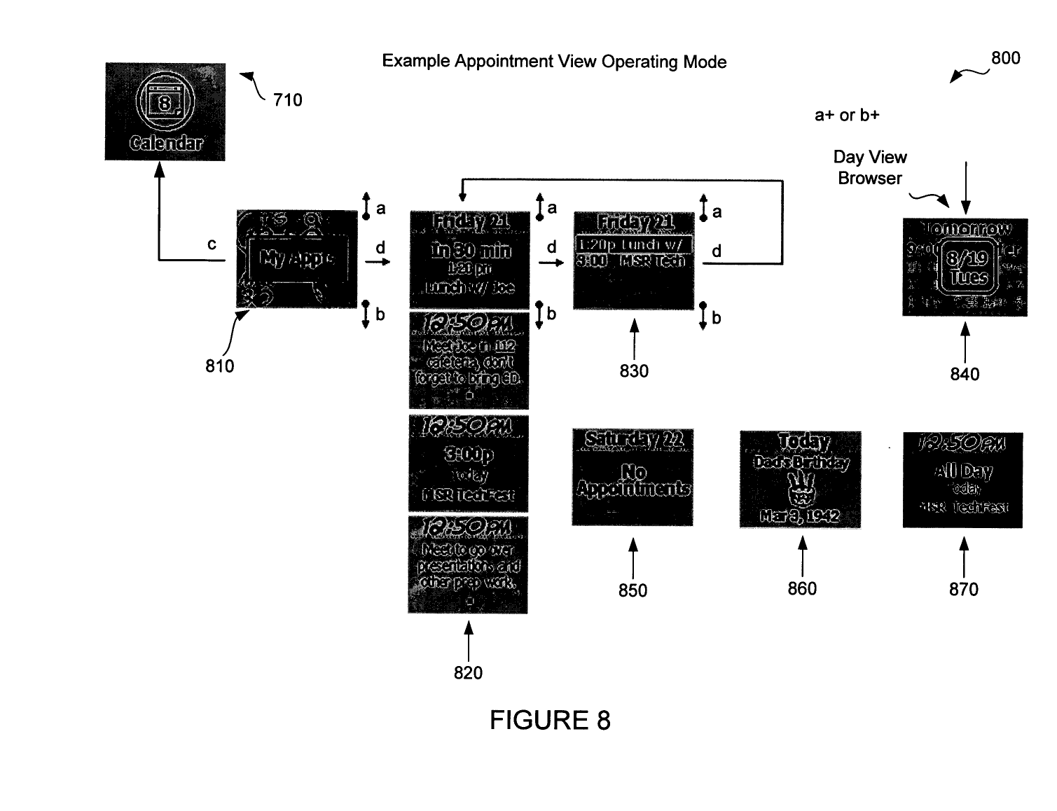

The channel splash-screen is dismissed after the appointment mode is activated. After the channel splash-screen is dismissed, the first upcoming appointment (e.g., see 820 from FIG. 8) is displayed on the electronic device. The appointment mode of the channel may include many display views (820) that each correspond to appointments on the schedule. Example appointments that are illustrated in FIG. 8 include “Lunch w/Joe”, and “MSR Techfest”.

Each appointment view may be partitioned into a header section, and a main body section. The header section may display the current time or date. The header section may be formatted such that: expired appointments are indicated by text such as “Past”, immediate upcoming appointments are indicated by text such as “Next”, today's appointments are indicated by text such as “Today”, and subsequent days appointments are indicated by the day of the week followed by a numerical date (e.g., “Mon 10”, “Tue 11”, etc.).

The header section may also have two views as illustrated in FIG. 8. A first header view indicates the current date such as “Friday 21”, while the second header view indicates the current time such as “12:50 PM”. After a first delay time, the header section of the display screen may change from the first header view to the second header view. After a second delay time, the header section of the display screen may change back to the first header view. The toggling of the display section may be referred to as a passive interaction that is activated by “parking” the electronic device in the appointment mode of the calendar channel. The passive interaction is deactivated by activation of one or more selectors on the electronic device.

The main body section of each appointment view may indicate the amount of time remaining until the scheduled appointment (e.g. “in 30 min”, “3:00 P”, etc.), the time of the scheduled appointment (e.g. “1:20 pm”, “3:00 P”, “All Day”), and an abbreviated form of the appointment detail. The main body section may also include a combination of text and graphic elements that are centered on the display both horizontally and vertically beneath the header section (e.g., see 860). “All day” appointments are illustrated by screens 860 and 870. Similar to the header section, the main body section of the display area may be periodically updated when passive interaction is activated by parking the device on the appointment mode of the calendar channel. While the current appointment is parked on the display, the electronic device continues to monitor the time relative to the appointment so that the display can be updated accordingly. For example, the time until the next appointment will count down while the channel is parked on the appointment view.

Appointments are automatically selected when the day and time of the appointment become the most imminent non-expired appointment in the schedule. Expired appointments may not be displayed on the device unless actively browsed (e.g., activation of the “previous” function by depressing the “a” selector) since they are no longer imminent appointments. The electronic device will display the summary for the currently selected appointment while the appointment mode is active. The selected appointment may be manually advanced by pausing the appointment mode with the activation of the next and previous selectors (e.g., “a” and “b” selectors). An empty or “no appointments” screen such as display screen 850 can be displayed when there are no imminent appointments remaining.

The electronic device may be arranged to apply a logic rule set to dynamically change the content that is associated with the header and main body sections of the display. The rule set changes the behavior of the device as time progresses. An example rule set requires that appointments that are more than 30 minutes in the future are indicated as “Today” instead of “In XXX Minutes”. For example (See FIG. 8), a single appointment (e.g., “MSR Techfest”) is scheduled for 3 PM on Friday 21^{st}. Early in the day (e.g., 8 AM), the appointment is in the distant future and the time of appointment is indicated as “3 PM” and “Today”. The display changes to indicate “In 30 min.” at 2:30 PM of that day, and subsequently counts down to the appointment. Other rule sets may also be applied such as appointments or events that are beyond 12 AM are indicated as “Tomorrow”, appointments or events that are beyond 48 hours are indicated as “in XXX days”

The appointment view mode includes a special type of selection list that includes a header section and an abbreviated list of all of the events and appointments for each day. The list is organized on a day-by-day basis. An example list for a days schedule is illustrated by view 830 in FIG. 8. The selection list for the days schedule may be organized as a header section, and a main body section. The header section may display the currently selected day such as, for example, “today”, “yesterday”, “tomorrow”, and a day followed by a numerical date (e.g., “Thu 17”). The main body section may include an area for time of the appointment or event, and an area for a brief description. The time of the appointment or event may be left justified in a first column of the display, while the brief description may be left justified in a second column of the display. All day events do not include a time and thus the brief description of the all day event may be centered on the display area for the item.

Activation of the next and previous selectors (e.g., the “a” and “b” selectors) will allow the user to select the list items from the days schedule. The currently selected item in the schedule is indicated by a graphical indicator such as a reverse blit effect on the text associated with the selected item. The selected item activation of the “enter” (e.g., the “d” selector) will enter the detailed view for the selected item. After the detailed view is active, activation of the “next” and “previous” selectors will scroll through the various items in the days schedule in detailed view. Activation of the “enter” function from the detail view cycles the display to the day view mode splash-screen, which permits selection of another mode if desired.

A day browser may be available in the appointment view operating mode of the calendar channel. The day browser is activated by accessing an alternate selector functions such as “a+” and/or “b+”. The alternate selector function may be accessed by sustained activation of a selector button for a predetermined time interval (e.g., two seconds). The day browser function may be arranged as an overlay that includes the current date (e.g., “Aug. 19 Tues”) as illustrated by display screen 840 in FIG. 8.

The detailed views (e.g., display screens 820) that are associated with a current appointment can be displayed by activating the next function (e.g., the “b” selector). The detailed views may span a single display screen or multiple display screens. Detailed views can be scrolled through using the “previous” and “next” selectors. When the current detail view is the last view for a particular appointment, activation of the “next” selector will go to detail view of the next imminent appointment. Activation of the “enter” function from the detail view cycles the display to the list selection screen, which permits selection of another appointment if desired.

Each appointment may have a status that is indicated by an alternating view when the appointment operating mode is active. As shown in FIG. 6 and FIG. 8, each appointment has a header section and a main body section.

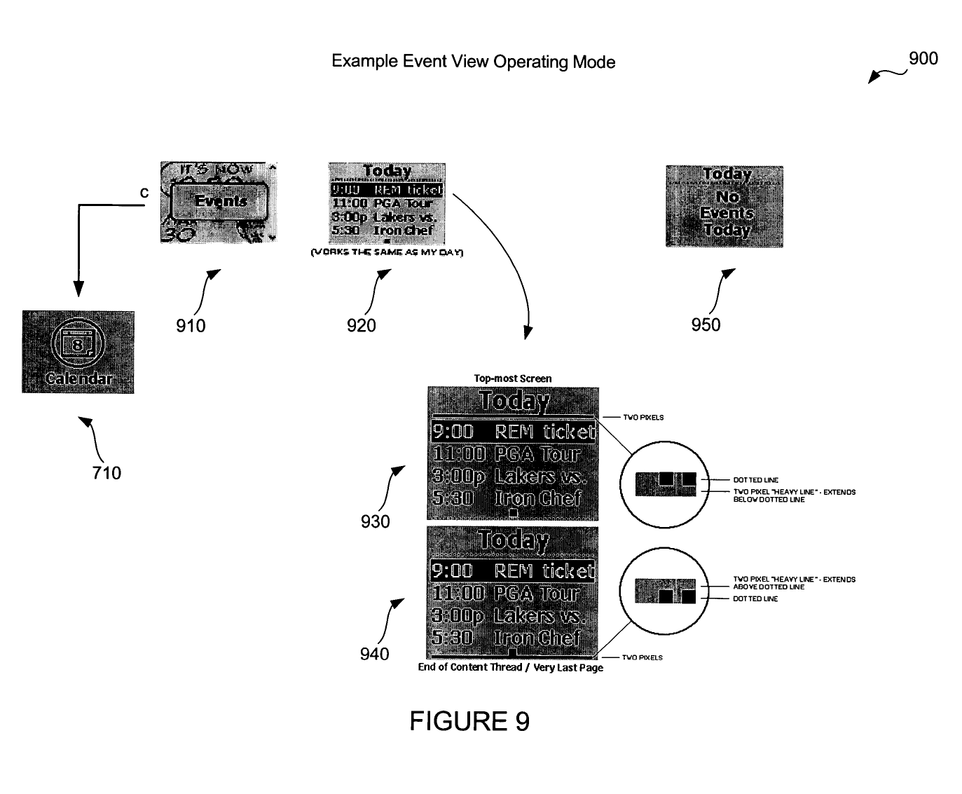

The event view mode is illustrated in FIG. 9, and may include a number of views (900) that correspond to a list formatted overview of the user's event schedule for the current day. This mode functions substantially the same as the appointment view operating mode that was described previously with respect to FIG. 8.

Appointment lists such as from the appointment view and event view operating modes may be configured with appointment bookends as illustrated by display screens 930 and 940 in FIG. 9. The header section of display screen 930 is separated from the main body section by a horizontal line that indicates the top of the list, while the bottom of display screen 930 includes a dotted horizontal line to indicate that the list continues on the next display screen. Similarly, the header section of display screen 940 is separated from the main body section by a dotted horizontal line that indicates the top of the list is on the previous screen, while the bottom of display screen 940 includes a horizontal line to indicate the end of the list for the day's events and/or appointments. An empty event or “no events” screen such as display screen 950 can be displayed when there are no events scheduled for the day.

The month view mode is illustrated in FIG. 10, and may include a number of views that correspond to each month of the user's schedule. This mode allows a user to view a monthly calendar. The monthly calendar includes a graphical indicator of the current day such as, for example, an inverse blit effect on the current day (see e.g., 1020). The month view includes a header section and a calendar section. The header section of the display includes a date indicator such as the month and year of the currently selected calendar (e.g., “February 2002”). The calendar section is laid out similar to a desktop calendar as shown in FIG. 10.

Activation of the next and previous selectors (e.g., the “a” and “b” selectors) in the month view operating mode will cycle the display through previous and subsequent months on the calendar. A month browser (see e.g., 1030) is available in the month view operating mode of the calendar channel. The month browser is activated by accessing an alternate selector functions such as “a+” and/or “b+”. The alternate selector function may be accessed by sustained activation of a selector button for a predetermined time interval (e.g., two seconds). The month browser function may be arranged as an overlay that includes the currently selected month (e.g., “November '02”) as illustrated by display screen 1030 in FIG. 10. Activation of the “c” selector or “mode select” function from the detail view cycles the display to the month view mode splash-screen, which permits selection of another mode if desired.

### Calendar Channel Customization

The calendar channel is arranged to provide simple access to time based schedules and information on the electronic device. Appointments and reminder type functions are customized based on user preferences. The user preferences and schedules may be provided as information that is retrieved from broadcast transmission such as that previously described. Schedules can be selected via a computer type interface such as through an internet based application, a computer based application, or any other reasonable method of accessing and altering scheduling information. Schedules may be synchronized such that a user only is required to update the scheduling information in a single location.

In one example, a subscriber to the calendar feature can access an internet based application such as the MSN® calendar service to select or change various features for the calendar channel. In another example, a subscriber uses an application program such as Microsoft® Outlook® to revise and set schedules. Each day at a predetermined time (e.g., midnight), the appointments from the previous day can be deleted, and appointments for the next days are updated. Throughout the day, various facilities can be provided such that the revisions to the calendar channel content are synchronized through the broadcast transmissions that are received by the electronic device.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for navigating stored content on an electronic device that includes a display and an interface selection device, wherein the stored content is associated with a schedule of a calendar, the method comprising:
monitoring the interface selection device;
selecting a current operating mode as an appointment view operating mode when a calendar channel is activated;
selecting an appointment from the schedule when the appointment view operating mode is activated;
selecting a current view that is associated with the selected appointment;
updating the display with the current view, wherein the display is partitioned into a header region and a main body region;
initiating a next function in response to the interface selection device; and
changing the current view to a next view when the next function is initiated and the appointment view operating mode is active.

2. The method of claim 1, further comprising: initiating a calendar channel splash screen when a calendar channel is activated on the electronic device.

3. The method of claim 2, wherein the calendar channel splash screen includes a date indicator that changes based on the current date.

4. The method of claim 2, further comprising: dismissing the channel splash screen after the calendar splash screen is displayed for a predetermined time interval.

5. The method of claim 2, further comprising: initiating an enter function in response to the interface selection device, and dismissing the channel splash screen in response to the enter function after the calendar splash screen is displayed.

6. The method of claim 1, wherein selecting an appointment from the schedule when the appointment view operating mode is activated further comprises: selecting a most imminent non-expired appointment from the schedule for the current day, wherein the most imminent non-expired appointment changes over time such that the selection also dynamically changes.

7. The method of claim 1, wherein the selected appointment view corresponds to a no appointments screen when there are no remaining appointments in the schedule for the current day.

8. The method of claim 1, further comprising: automatically alternating between different views that are associated with the header region of the display such that the header region periodically changes after a timeout interval expires when the appointment view operating mode is active.

9. The method of claim 8, wherein the header region includes a representation of at least one of: a current day of the week, a current date of the month, and a current time of the day.

10. The method of claim 1, further comprising: automatically alternating between different views that are associated with the main body region of the display such that the main body region periodically changes after a timeout interval expires when the appointment view operating mode is active.

11. The method of claim 10, wherein the main body region includes a representation of at least one of: a current day of the week, a current date of the month, a current time of the day, a time remaining until the selected appointment, a time duration of the selected appointment, and a summary of the selected appointment.

12. The method of claim 1, wherein the next view corresponds to another display screen that is associated with the selected appointment when the selected appointment spans more than one display screen.

13. The method of claim 1, wherein the next view corresponds to a next appointment form the schedule when the current view corresponds to the last view that is associated with the selected appointment.

14. The method of claim 1, further comprising: initiating a previous function in response to the interface selection device when the appointment view operating mode is active, and changing the current view to a previous view when the previous function is initiated and the appointment view operating mode is active.

15. The method of claim 14, wherein the previous view corresponds to another display screen that is associated with the selected appointment when the selected appointment spans more than one display screen and the current view is not the first view that is associated with the selected appointment.

16. The method of claim 14, wherein the previous view corresponds to a previous appointment from the schedule when the current view corresponds to the first view that is associated with the selected appointment.

17. The method of claim 1, further comprising: activating a day browser in response to the interface selection device when the appointment view operating mode is active, wherein the day browser includes an indicator of a date that is associated with the selected appointment on the display, wherein a currently selected day can be changed with the interface selection device while the day browser is active.

18. The method of claim 17, wherein the indicator of the date from the day browser corresponds to a screen overlay that includes the current date in a textual representation.

19. The method of claim 1, further comprising: activating a selection list in response to the interface selection device when the appointment view operating mode is active, wherein the selection list is organized as a list of items that are associated with an appointment in the schedule for a selected day, and wherein the interface selection device is configured for selecting one of the items in the list.

20. The method of claim 19, wherein the selection list includes a header section and a main body section, wherein the header section indicates the selected day, wherein the main body section includes a time sorted list of the appointments that are associated with the schedule for the selected day, and wherein the selected item from the list is indicated by a visual cue.

21. The method of claim 19, wherein the selection list includes items that span more than one display screen, and wherein a bottom region of the display screen includes an indicator that indicates an end of the list.

22. The method of claim 19, wherein the selection list includes items that span more than one display screen, and wherein a top region of the display screen includes an indicator that indicates a beginning of the list.

23. The method of claim 1, further comprising: activating a mode select function in response to the interface selection device when the appointment view operating mode is active, displaying a mode-splash screen on the display when the mode select function is active, wherein the mode-splash screen indicates the selected operating mode, and changing the selected operating mode with the interface selection device when the mode select function is active.

24. The method of claim 23, wherein the mode select function is deactivated in response to at least one of: activation of a selector on the interface selection device, and expiration of a timeout condition without the activation of the selector on the selection interface device.

25. The method of claim 23, wherein the selected operating mode corresponds to at least one of: the appointment view operating mode, an event view operating mode, and a month view operating mode.

26. The method of claim 1, further comprising:
selecting the current operating mode as an event view operating mode when a mode select function is activated in the calendar channel;
selecting an event from the schedule when the event view operating mode is activated; and
selecting the current view that is associated with the selected event;

27. The method of claim 26, further comprising: changing the selected event to a next event when the next function is initiated and the event view operating mode is active.

28. The method of claim 1, further comprising:
selecting the current operating mode as a month view operating mode in response to the interface selection device when a mode select function is activated in the calendar channel;
selecting a month that is associated with the calendar when the month view operating mode is activated; and
selecting the current view that is associated with the selected month.

29. The method of claim 28, further comprising: changing the selected month to a next month when the next function is initiated and the month view operating mode is active.

30. An apparatus for navigating stored content that is associated with a schedule of a calendar, the apparatus comprising:
a display;
a user interface that includes a selector;
a means for monitoring the user interface;
a means for selecting a calendar channel;
a means for mapping a context of the user interface to another context that is associated with a selected operating mode;
a means for selecting a current operating mode as an appointment view operating mode when a calendar channel is activated;
a means for selecting an appointment from the schedule when the appointment view operating mode is selected;
a means for selecting a current view that is associated with the selected appointment;
a means for updating the display with the current view; and
a means for changing the current view to a next view when a next function is initiated and the appointment view operating mode is active.

31. The apparatus of claim 30, wherein the means for selecting the appointment from the schedule when the appointment view operating mode is activated further comprises: a means for selecting a most imminent non-expired appointment from the schedule for the current day.

32. The apparatus of claim 30, wherein the selected appointment view corresponds to a no appointments screen when there are no remaining appointments in the schedule for the current day.

33. The apparatus of claim 30, further comprising: a means for automatically alternating between different views when the apparatus is parked for a predetermined timer interval.

34. The apparatus of claim 33, wherein each different view includes a different header region that periodically changes after another timeout interval expires.

35. The apparatus of claim 33, wherein each different view includes a different main body region that periodically changes after another timeout interval expires.

36. The apparatus of claim 30, further comprising:
a means for selecting the current operating mode as an event view operating mode when a mode select function is activated in the calendar channel;
a means for selecting an event from the schedule when the event view operating mode is activated; and
a means for selecting the current view that is associated with the selected event.

37. The apparatus of claim 30, further comprising:
a means for selecting the current operating mode as a month view operating mode in response to the interface selection device when a mode select function is activated in the calendar channel;
a means for selecting a month that is associated with the calendar when the month view operating mode is activated; and
a means for selecting the current view that is associated with the selected month.

38. An apparatus as in claim 30, further comprising: a means for customizing that is arranged to customize the schedule of the calendar.

39. An apparatus as in claim 30, further comprising: a means for synchronizing that is arranged to synchronize the schedule of the calendar with an application program.

40. An apparatus for navigating stored content that is associated with a schedule of a calendar, the apparatus comprising:
a display;
a user interface that includes a selector; and
an electronic system that is arranged to interact with the user interface and the display, wherein the electronic system is configured to:
select a current operating mode when a calendar channel is activated;
change the current operating mode in response to the user interface when a mode-splash screen is active on the display;
select a record from the schedule that is associated with the current operating mode;
select a current view that is associated with the selected record;
change the current view to another view that is associated with the selected record when the apparatus is parked for a predetermined time interval;
update the display with the current view;
initiate a next function in response to the selector; and
change the current view to a next view when the next function is initiated, wherein the current view is associated with at least one of: the selected record, and another record from the schedule that is associated with the current operating mode.
